(19) United States
(12) Patent Application Publication
(10) Pub. No.: US 2014/0068561 A1
(43) Pub. Date: Mar. 6, 2014

(54) CONTROL SYSTEM HAVING AUTOMATIC COMPONENT VERSION MANAGEMENT

(71) Applicant: Bibhrajit HALDER, Peoria, IL (US)

(72) Inventor: Bibhrajit HALDER, Peoria, IL (US)

(73) Assignee: Caterpillar Inc.

(21) Appl. No.: 13/603,668

(22) Filed: Sep. 5, 2012

(51) Int. Cl. G06F 9/44

(52) U.S. Cl. 717/122

(57) ABSTRACT

A component version management system for a machine is disclosed. The component version management system has a software driven component located on the machine, a data system located offboard the machine, and a data system controller in communication with the software driven component and the data system. The data system controller is configured to automatically collect at least one of a software and hardware version of the component, analyze the information for at least one of software and hardware mismatch, and generate a notification for display in the machine when software or hardware mismatch is detected.

### TECHNICAL FIELD

This disclosure relates generally to a control system and, more particularly, to a machine control system having automatic component version management.

### BACKGROUND

Machines such as autonomous construction equipment, passenger vehicles, vocational trucks, and other machines known in the art are often equipped with one or more components having software or hardware that require periodic service upgrades for operation of the components. The components work in concert with each other and are sometimes calibrated to function with specific versions of software and/or hardware in neighboring components within the same system. Software and hardware version mismatch between two or more components can cause the system to function in an unexpected way, or in some circumstances, may cause one or more components to stop functioning.

Currently, the software version for each individual component is recorded at a corresponding electronic control module onboard the machine, and has to be retrieved manually by a technician with module reading equipment. Maintaining a history of software and/or hardware versions for each component includes checking the software version of each component at the electronic control module, manually recording the software version, and subsequently tracking a software version history over time via an external tool such as a spreadsheet. A software and hardware version list is then generated and manually compared against a record of expected software and hardware versions to identify any mismatches. When a mismatch is spotted, appropriate action is then taken. The action can include alerting the machine operator of the mismatch, and/or scheduling a maintenance visit for a software upgrade to the mismatched components. Identifying software and/or hardware version mismatch between individual components using current methods can be cumbersome and increase the possibility of error.

One exemplary method used to identify an incorrect or mismatched component is described in U.S. Patent Application Publication No. US 2011/0220560 (the '560 publication) filed by Verdegan on Mar. 9, 2011. The '560 publication describes a system in which a component, such as an engine filter, is identified as genuine or not genuine. A surface acoustical wave sensor is mounted on the filter, which transmits a signal to an interface module operatively connected to an electronic control module (ECM) of a host machine, the signal indicating whether or not the component is appropriate. The system described in the '560 publication updates a maintenance history log located at the electronic control module (ECM), and warns an operator of possible used, defective, non-genuine or counterfeit components. When a serviceable component is determined to not be genuine after detection, appropriate action is taken to warn operators and document such findings.

Although the '560 publication describes a system for detecting the presence of a suitable component, it does not provide for system level management of software versioning for each component. Pertinent information, such as the history of appropriate component installations, presumably must still be retrieved manually from each ECM. Furthermore, the '560 publication appears to track only matches and mismatches of physical hardware, and is silent as to other important factors.

The system of the present disclosure is directed towards overcoming one or more of the problems as set forth above.

### SUMMARY

One aspect of the present disclosure is directed to a component version management system for a machine. The component version management system may include a software driven component located on the machine, a data system located offboard the machine, and a data system controller in communication with the software driven component and the data system. The data system controller may be configured to automatically collect at least one of software version and hardware version of the software driven component, analyze the information for at least one of software and hardware mismatch, and generate a notification in the machine when a software or hardware mismatch is detected.

Another aspect of the present disclosure is directed to a computer-implemented method of managing a software version of a machine component. The method may include collecting information from the machine component, analyzing, by one or more processors, the information for at least one of software and hardware version mismatch, and generating, by the one or more processors, a notification when a software or hardware version mismatch is detected.

### BRIEF DESCRIPTION OF THE DRAWINGS

FIG. 1 is a schematic and pictorial illustration of an exemplary disclosed machine;

FIG. 2 is a diagrammatic illustration of an exemplary component version management system that may be used in conjunction with the machine of FIG. 1; and

FIG. 3 is a flowchart illustrating an exemplary disclosed method of operating the component version management system of FIG. 2.

### DETAILED DESCRIPTION

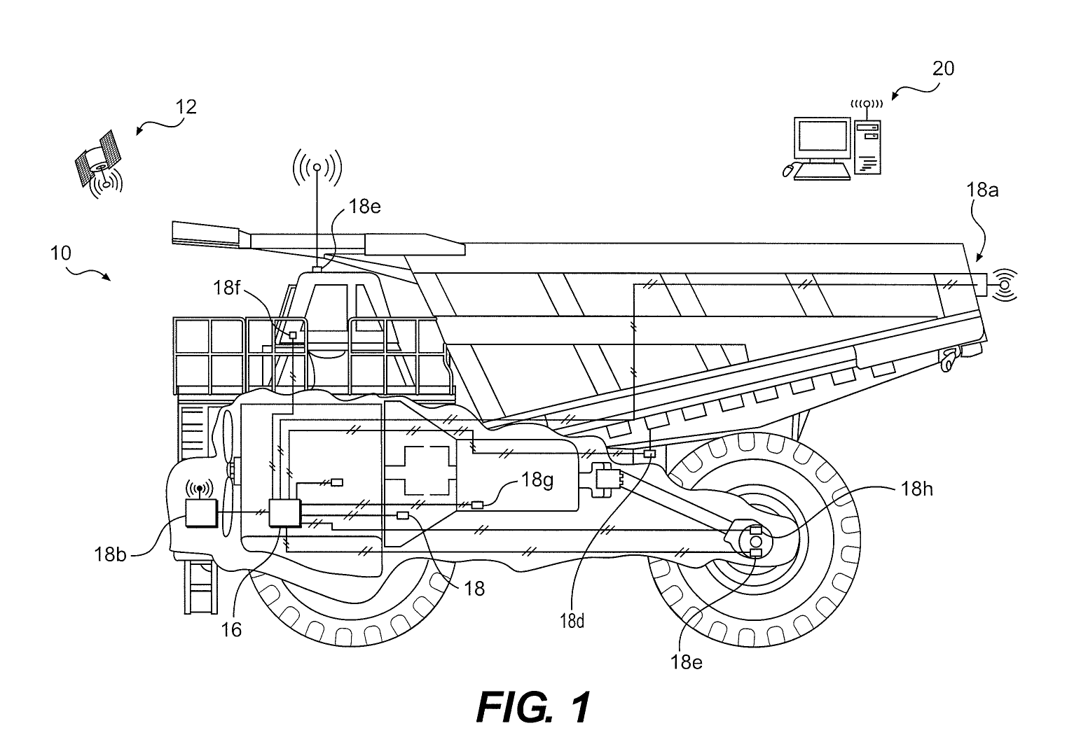

FIG. 1 illustrates an exemplary machine 10 for use in a worksite. Machine 10 may embody an autonomous, semi-autonomous or manually controlled mobile machine. For example, machine 10 may be an earth moving machine such as an off-highway haul truck (shown in FIG. 1), a wheel loader, a motor grader, or any other mobile machine known in the art. Machine 10 may alternatively embody a non-earth moving machine such as an on-road vehicle, a passenger vehicle, a stationary generator set, a pumping mechanism, or any other suitable operation-performing machine.

Machine 10 may have one or more software driven components 18 that facilitate its operation at the worksite. For the purposes of this disclosure, a software driven component 18 may be considered any component that utilizes software and/or hardware in its operation. Examples of software driven components 18 may include various auxiliary equipment such as a sensing device module 18a. Auxiliary equipment may be onboard the machine 10 to perform various tasks during machine 10 operation that aid in the application of the machine 10 on the worksite. For example, sensing device module 18 may be used to sense the physical surroundings of the machine 10 using lidar, radar and/or the like. Software drive components 18 may further include a locating device 18b, used to geographically locate the machine 10, and a communications module 18c, used to facilitate communication between the machine 10 and another device or system remotely located from the machine 10. Additional examples include a chassis control module 18d, used to control operational aspects of a machine chassis, a brake control module 18e used to control operational aspects of a braking system, a steering control module 18f, a transmission control module 18g, a tire control module 18h, and an auxiliary equipment module (not shown). Other types of devices not named herein may be included on the machine 10, which may communicate with one another and/or communicate with other software driven components. While other devices are not explicitly named, it is to be understood that such devices may cooperate with one another, and may benefit from software and/or hardware compatibility matching between components.

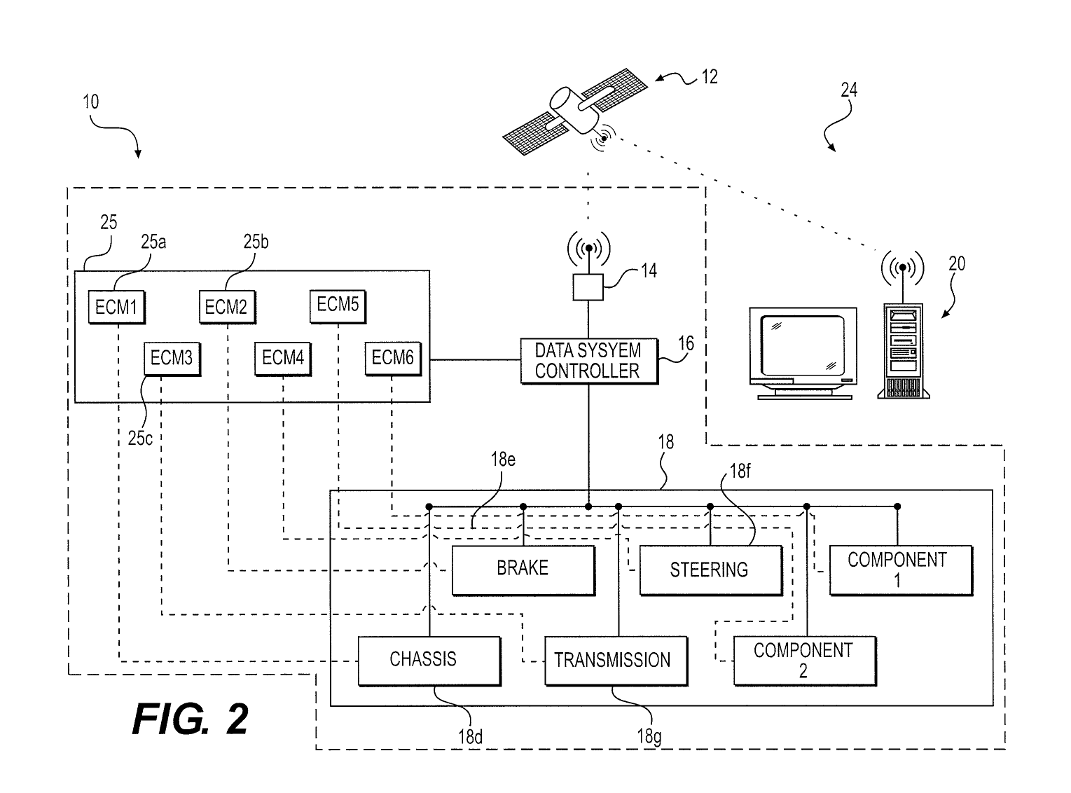

As shown in FIG. 2, one or more machine controllers 25 may be onboard the machine 10. A machine controller 25, embodied as an electronic control module (ECM), may be operably connected to one or more software driven components 18. For example, machine controller 25 may be in communication with a software driven component 18, such as a brake control module 18e, and together function as a brake control system that works in conjunction with an autonomous machine control system and/or operator interface (not shown). Machine controllers 25 may communicate with one another, and/or communicate with an onboard data system controller 16.

Data system controller 16 may coordinate the function of various machine controllers 25 and/or software driven components 18. For example, software driven components 18 may report to machine controllers 25, and each of machine controllers 25 may report to data system controller 16. Data system controller 25 may be responsible for collecting information regarding the software driven components 18 and for processing the information.

Data system controller 16 may include any means for monitoring, recording, storing, indexing, processing, and/or communicating the operational aspects of machine 10 described above. These means may include components such as, for example, a memory, one or more data storage devices, a central processing unit, or any other components that may be used to run an application. Furthermore, although aspects of the present disclosure may be described generally as being stored in memory, one skilled in the art will appreciate that these aspects can be stored on or read from different types of computer program products or computer-readable media such as computer chips and secondary storage devices, including hard disks, optical media, CD-ROM, or other forms of non-transitory computer readable media.

Data system controller 16 may also include a means for communicating with an offboard data system 20. For example, data system controller 16 may include hardware and/or software that enables sending and receiving of data messages through a direct data link (not shown) or a wireless communication link (not shown). The wireless communications may include satellite 12, cellular, infrared, and any other type of wireless communications that enable data system controller 16 to exchange information with offboard data system 20. It is contemplated that a separate module may be included within data system controller 16 to facilitate the communication of data between data system controller 16 and offboard data system 20, if desired.

Offboard data system 20 may represent one or more computing systems of a business entity associated with machine 10, such as a worksite operator, manufacturer, dealer, retailer, owner, service provider, or any other entity that generates, maintains, sends, and/or receives information associated with machine 10. The one or more computing systems may include, for example, a laptop, a work station, a mobile computing device, a mainframe, and other computing systems known in the art.

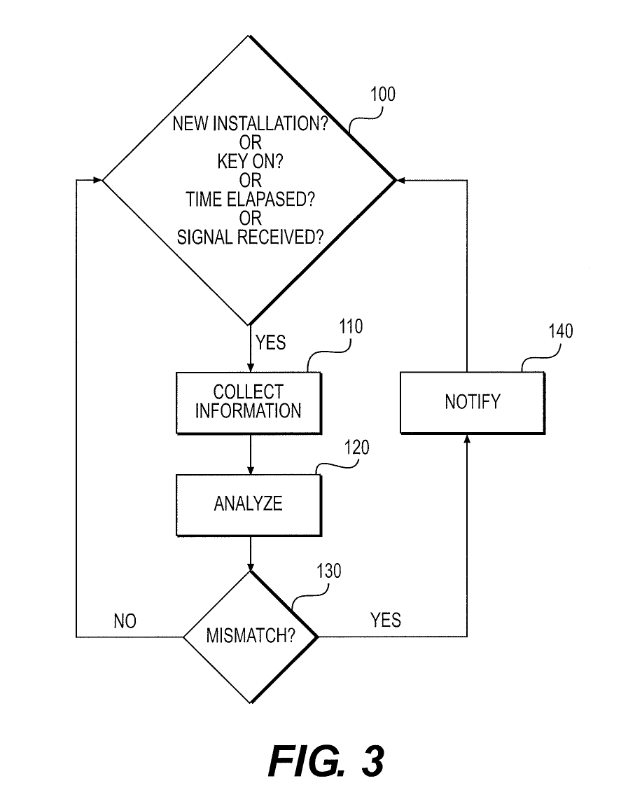

FIG. 3 illustrates a flowchart describing a method of managing the software and/or hardware of 18. FIG. 3 will be discussed in the following section to further illustrate the disclosed system and its operation.

### INDUSTRIAL APPLICABILITY

The disclosed method and system may provide an accurate and reliable way for managing software and hardware versions in onboard software driven components. Specifically, because the disclosed system and method provide for automatic version management, the amount of manual effort expended to identify version mismatch and record a version history of components of a machine may be low, and the likelihood of error may be reduced. The operation of control system having automatic version management 24 will now be described with respect to FIG. 3.

As illustrated in the flowchart of FIG. 3, the first step of the component version management process may include determining when the process should begin. In one embodiment, the process may begin when a new software driven component is installed in machine 10. In another embodiment, the process may begin when machine 10 is started and/or keyed on. In another embodiment, the process may begin when a specific interval of time has elapsed since a previous process cycle. For example, while machine 10 is in operation, control system 24 may collect and analyze the information at a predetermined time interval of five seconds. In yet another embodiment, the process may begin when a start process signal is received by the onboard control system from an external source, such as offboard data system 20. Data system controller 16 may determine that one or more software driven components has been newly installed by monitoring a power and/or communication signal sent to or received from the component 18 by machine controller 25. Alternatively, the component version management process may be triggered in other ways. For example, the process may be manually triggered by a service technician upon installation, if desired. The component version management process may also be manually triggered by a request from an individual, such as a mine operator, who has an operative connection to the control system 24. The request from an individual may cause the control system 24 to return version information to the operator even if a software and hardware mismatch has not been detected. Accordingly, the process of FIG. 3 is configured to commence following any one or more of the events described above (step 100).

In the event that the process has been triggered, data system controller 16 may initiate automatic collection of software and hardware information (step 110). The collected software and hardware information may include component information such as, for example, an identifying serial number or other identification, a model number, a hardware version number, a software version number, a software and/or hardware release date, a software and/or hardware expiration date, a software and/or hardware group description, a fabrication or testing date or facility, an operating system version, a firmware version, and/or other related component information. The collected information may also include user information, such as, information identifying the particular machine 10 into which software driven component 18 is installed, information associated with the selling or servicing dealership associated with the machine 10 and/or any component and/or systems installed on the machine 10, customer information (i.e., name, billing address, intended work location, contact information, and/or the like), and other user-related information known in the art. The component information may be automatically collected via electronic communication with a memory of the newly installed software driven component 18 and/or other components and systems of machine 10. The information may be collected via optical, infrared or magnetic scanning of external or internal indices placed on or programmed into machine 10 during fabrication or installation. The component information may be automatically collected to determine a hardware or electronic configuration of software driven component 18 by communication with data system controller 16, and/or communication with offboard data system 20, or in any other appropriate manner.

Collecting software and hardware information (step 110) may be accomplished by control system 24. Control system 24 may query each system and subsystem of machine 10 to determine if there are additional unique software driven components 18 from which information should be collected. Control system 24 may accomplish the data collection by means of data system controller 16 and/or any other combination of system components such as, for example, one or more of machine controllers 25.

Following receipt of the automatically-collected information, the information may be analyzed by control system 24 (step 120) to identify any software and hardware version mismatch. The analysis may be processed by data system controller 16, or other processing means within control system 24. Analyzing the collected information (step 120) may further include identifying one or more elements of the information that has changed since a previous analysis, and comparing the one or more elements of information against a master list of compatible component software and hardware matches. Data system controller 16 may be further configured to automatically update the master list with information related to at least one of software and hardware version, and automatically send the information to the data system 20 located offboard the machine 10.

A software and hardware version mismatch of software driven component 18 may occur as a result of altering machine 10 in some way. For example, software and hardware version mismatch may occur when the software of one component 18 is upgraded, and the upgraded software version is not compatible with one or more other components or systems of machine 10. Other forms of mismatch may occur when the version of component software on a component 18 of machine 10 is incompatible with one or more versions of hardware or software of software driven component 18. Version mismatch may also be created when a software and/or hardware version is incompatible with machine 10 on which the component installation is made. Other types of software and hardware version mismatch may be detected by the presently disclosed control system 24.

If a software and hardware mismatch is detected (step 130), a notification may be generated on a display operatively connected to machine 10 indicating the mismatch (step 140). The notification may be a visual display, an audio notification, etc. According to yet another embodiment, a notification is generated by control system 24 and transmitted to the offboard data system 20 (step 140).

According to one embodiment, the version information of software driven component 18 may be processed by control system 24 in such a way as to make the information displayable on a graphic user interface located onboard machine. The displayed information may include a readily identifiable notification on the screen showing one or more mismatches in such a way as to bring attention to the mismatch information. Displaying mismatch information in such a fashion may provide an efficient way for a technician, operator or other individual to be made immediately aware of a software and hardware mismatch on machine 10, so that appropriate action can be taken. When information is readily viewable on the screen, the need for tedious comparison between an appropriate software version list and the software currently installed on software driven components 18 may be avoided. Furthermore, the potential for human error in comparing a master version list to the currently installed software driven components 18 may also be reduced or avoided.

Analyzing the collected information may further include recording the version history for each software driven component 18 on the memory of data system controller 16. Analyzing the collected information may be done at any time after collecting the information. The version history information may include, but is not limited to any one or more of: component identification information that uniquely identifies the component 18, the date that component 18 was installed, a name of component 18, a description of component 18, machine 10 identification, a hardware version, a hardware serial number, a firmware version, an operating system version, a software name, a software version, a release date of software and/or hardware, a software expiration date, and/or a group description.

The flow chart depicted in FIG. 3 shows one possible order in which control system 24 described herein is operated. Those skilled in the art will appreciate that a different logical order may be utilized in the practice of the presently disclosed control system 24, if desired. It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A component version management system for a machine, comprising:
a software driven component located onboard the machine;
a data system located offboard the machine; and
a data system controller in communication with the software driven component and the data system, the data system controller being configured to:
automatically collect information comprising at least one of a software and a hardware version of the component;
analyze the information for at least one of software and hardware mismatch; and
generate a notification in the machine when software or hardware mismatch is detected.

2. The component version management system of claim 1, wherein the data system controller is located onboard the machine, and in communication with the software driven component via a machine controller.

3. The component version management system of claim 1, wherein the information further includes component identification information that uniquely identifies the component.

4. The component version management system of claim 1, further including a graphic user interface located onboard the machine and configured to display the notification.

5. The component version management system of claim 1, wherein the data system controller is configured to automatically collect and analyze the information upon installation of the software driven component on the machine.

6. The component version management system of claim 1, wherein the data system controller is configured to collect and analyze the information after startup of the machine.

7. The component version management system of claim 1, wherein the data system controller is configured to collect and analyze the information when a request is received from the data system.

8. The component version management system of claim 1, wherein the data system controller is configured to collect and analyze the information at a predetermined time interval.

9. The component version management system of claim 1, wherein the data system controller is configured to analyze the information by:
identifying one or more elements of the information that have changed since a previous analysis; and
comparing the one or more elements of information against a master list of compatible component software and hardware matches.

10. The component version management system of claim 1, wherein the data system controller is further configured to:
automatically update the master list with information related to at least one of software and hardware version; and
automatically send the information to the data system.

11. A computer-implemented method of managing a software version of a machine component, the method comprising:
collecting information from the machine component;
analyzing, by one or more processors, the information for at least one of software and hardware version mismatch; and
generating, by the one or more processors, a notification when a software or hardware version mismatch is detected.

12. The method of claim 11, wherein collecting information includes collecting component identification information that uniquely identifies the component.

13. The method of claim 11, wherein generating a notification includes generating a notification for display on a graphic user interface located onboard the machine.

14. The method of claim 11, wherein collecting and analyzing the information includes automatically collecting and analyzing the information upon installation of the machine component on the machine.

15. The method of claim 11, wherein collecting and analyzing the information includes automatically collecting and analyzing the information after a startup of the machine.

16. The method of claim 11, wherein collecting and analyzing the information includes automatically collecting and analyzing the information when a request is received from the data system.

17. The method of claim 11, wherein collecting and analyzing the information includes automatically collecting and analyzing the information at a predetermined time interval.

18. The method of claim 11, wherein analyzing the information includes:
identifying one or more elements of the information that has changed since previously collecting and analyzing the information; and
comparing the one or more elements of information against a master list of compatible component software and hardware matches.

19. The method of claim 11, further including automatically updating the master list with information related to software and hardware version.

20. A control system, comprising:
a software driven component;
a machine controller in communication with the software driven component and configured to automatically collect information comprising at least one of a software and a hardware version of the component;
a data system located offboard the machine; and
a data system controller located onboard the machine in communication with the software driven component, the machine controller and the data system, the data system controller being configured to:
collect the at least one of the software and the hardware version from the software driven component upon installation of the software driven component;
identify a software and a hardware version mismatch;
display a notification on a graphic user interface onboard the machine based on the mismatch;
compare the information with a master list; and
update the master list with the information comprising at least one of the software and the hardware version of the component.
